(19) United States
(12) Patent Application Publication
(10) Pub. No.: US 2007/0021103 A1
(43) Pub. Date: Jan. 25, 2007

(54) Method of protecting information in a mobile communication device

(76) Inventors: Xiang Zhao, Shanghai City (CN); Dai-Shui Ho, Taipei (TW)

Correspondence Address: NORTH AMERICA INTELLECTUAL PROPERTY CORPORATION, P.O. BOX 506, MERRIFIELD, VA, 22116, US

(21) Appl. No.: 11/458,679

(22) Filed: Jul. 19, 2006

(30) Foreign Application Priority Data
Jul. 20, 2005 (TW) 094124555

(51) Int. Cl. H04M 1/68

(52) U.S. Cl. 455/410

(57) ABSTRACT

Protection of contact information and call records in a mobile communication device, such as a cell phone, is accomplished through setting a protective password, setting a PIN password, setting an electronic recipient address, and using a short message service (SMS) to send a copy of the information to a storage device, such as another mobile communication device or an information services point, at the electronic recipient address if a protective password input does not match the protective password, or if a PIN password input does not match the PIN password. To further protect the information, the information can be deleted after the copy is sent.

### BACKGROUND OF THE INVENTION

1. Field of the Invention

The present invention relates to security of personal electronic devices, and more particularly, the present invention discloses a method for backing up and protecting information in a mobile communication device.

2. Description of the Prior Art

Please refer to FIG. 1, which is a diagram of detecting a subscriber identity sequence (SIM) card 11 of a cell phone 12 according to the prior art. After the cell phone 12 is turned on, the cell phone 12 detects a state of the SIM card 11 and displays a startup screen 121 in a liquid crystal display (LCD) of the cell phone 12. After a few seconds, the LCD displays a PIN password request screen 122, and waits for a correct password input from a user before entering a normal operating state.

Please refer to FIG. 2, which is a flow chart of detecting a SIM card in a cell phone. When a user of the cell phone turns on the cell phone in Step S21, the cell phone automatically detects the SIM card. In Step S22, the cell phone checks to see if the SIM card has been changed for another SIM card. If not, then the cell phone begins normal operation in Step S25. If the SIM card has been changed, however, then the cell phone enters a password check state in Step S23. When a correct password is entered, the cell phone proceeds to normal operation in Step S25. Else, the cell phone stops service in Step S24.

Normally, a user will store a large amount of information in the cell phone, such as a contact list, text messages, and a personal calendar. Thus, if the cell phone is stolen, then the user also loses all of the stored information, which is very inconvenient for the user, even more so if the cell phone is stolen by somebody who would exploit the stored information in the cell phone. So, it can be seen that, in the prior art method, only one layer of protection is offered, such that if the cell phone is stolen, a great risk occurs that the cell phone could be exploited, not to mention that the user loses the large amount of stored information in the cell phone, causing the user to lose contact with associates, and experience great frustration.

### SUMMARY OF THE INVENTION

It is therefore a primary objective of the present invention to provide a method for protecting information in a mobile communication device through a protective password and a PIN password. The present invention method includes setting the protective password, and setting the PIN password. Further, an electronic address specifying a backup storage device is set. If an incorrect PIN password is entered, or if an incorrect protective password is entered, the information in the mobile communication device can be sent to a storage device at the electronic address in the mobile communication device through a short message service (SMS). In this way, information loss and danger of theft are reduced, and the user can retrieve the information electronically at the preset electronic address.

Further, the present invention provides a backup mechanism for copying internal information in the mobile communication device, and a deleting mechanism for deleting the internal information in the mobile communication device. An advantage of the backup mechanism is an ability to generate a backup of the internal information of the cell phone. The deleting mechanism can then delete all of the internal information from the cell phone. In such a way, after the SMS service sends the internal information to the storage device at the preset electronic address in the phone, the internal information can be deleted immediately, thereby protecting against divulging of the internal information of the user, and also avoiding loss of the internal information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a method of cell phone authentication according to the prior art.

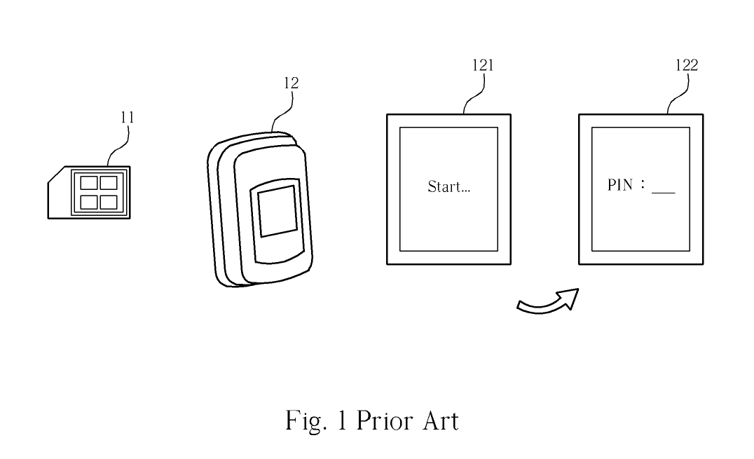

FIG. 2 is a flow chart showing the method of FIG. 1.

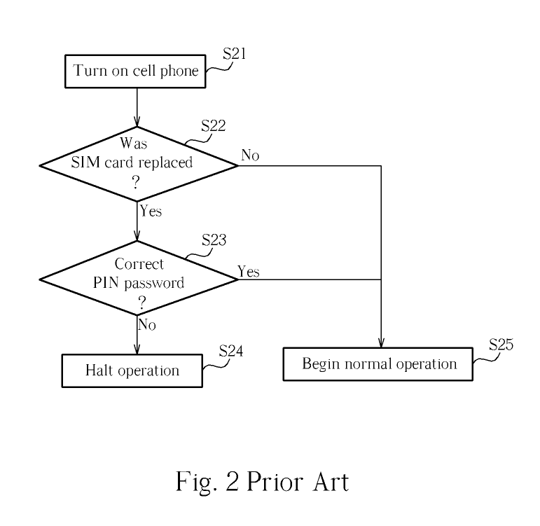

FIG. 3 is a diagram showing a method of cell phone authentication according to the present invention.

FIG. 4 is a flow chart showing the method of FIG. 3.

FIG. 5 is a flow chart of activating an intelligent theft discrimination sequence according to the present invention.

FIG. 6 is a flow chart of activating an intelligent backup sequence according to the present invention.

FIG. 7 is a flow chart of activating an intelligent deletion sequence according to the present invention.

FIG. 8 is a flow chart combing the flow charts of FIGS. 5-7.

### DETAILED DESCRIPTION

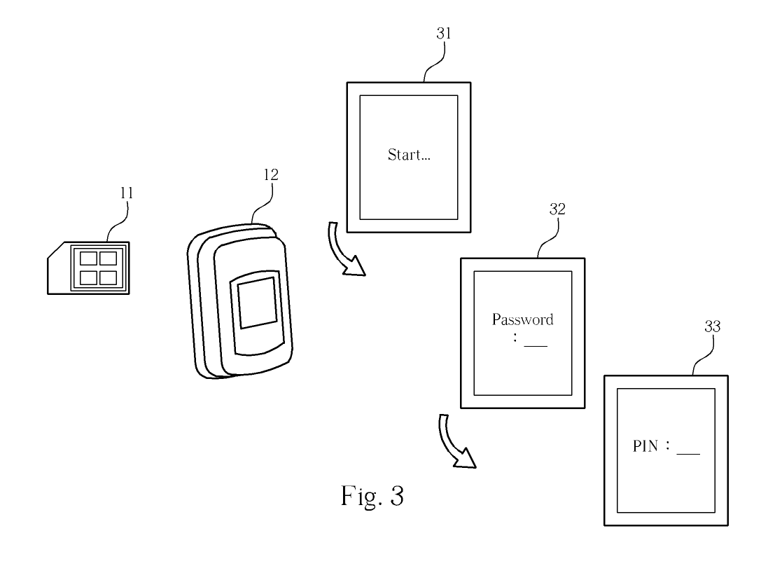

Please refer to FIG. 3, which is a diagram of authorizing a cell phone according to the present invention method. The present invention method can also be called theft protection method. The method is performed in a cell phone 12 comprising a SIM card 11. When the cell phone 12 is turned on, the cell phone 12 detects the SIM card 11, and displays a splash screen 31 that indicates the cell phone 12 has turned on. After a few seconds, the cell phone 12 displays a protective password requesting screen 32, and waits for a user to input a protective password. If the protective password inputted by the user matches a preset protective password in the cell phone 12, the cell phone 12 then proceeds to display a PIN password requesting screen 33, and waits for the user to input a PIN password. If the PIN password input by the user matches a preset PIN password, then the cell phone 12 enters a normal operation state.

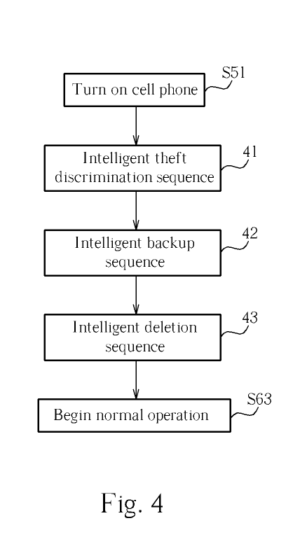

Please refer to FIG. 4, which is a block diagram of a SIM card change detector according to the present invention. FIG. 4 adds further explanation to the present invention theft protection method. When the cell phone is stolen, a new SIM card has been inserted into the cell phone, and when the cell phone is turned on, the cell phone enters an on state S51. At this point, the cell phone activates an intelligent theft discrimination sequence 41, which is used to determine if the SIM card has been replaced or if the protective password or the PIN password is different from the preset protective password or the preset PIN password, respectively. If any of the above conditions occurs, the cell phone activates an intelligent backup sequence 42, which uses a backup mechanism to make a backup copy of internal information in the cell phone. The backup mechanism then opens an SMS service of the cell phone, and after converting the internal information to a packet format, sends the internal information to a storage device at a preset address. Then, the cell phone activates an intelligent deleting sequence 43, and uses a deleting mechanism of the intelligent deleting sequence 43 to delete the internal information in the cell phone. When the internal information of the cell phone has been completely deleted, the cell phone enters a normal operation state S63, wherein no personal information originally on the cell phone can be obtained, thereby ensuring confidentiality of the internal information of the cell phone.

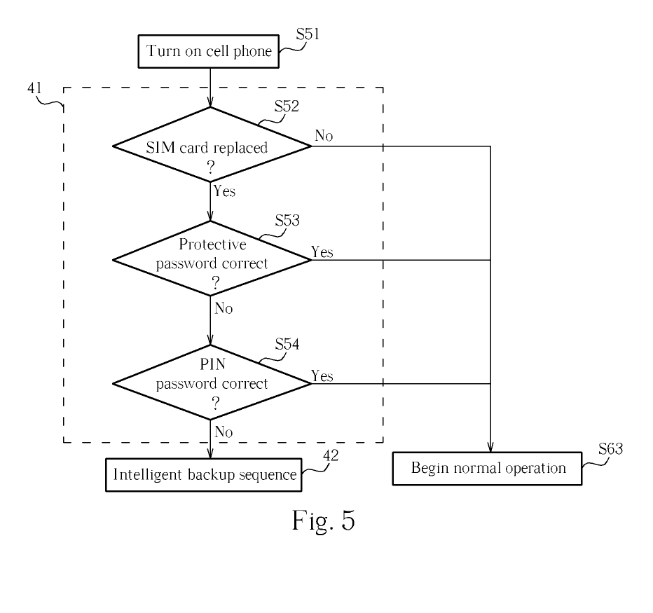

Please refer to FIG. 5, which is a flow chart of activating the intelligent theft discrimination sequence 41 according to the present invention. When the user turns on the cell phone, the cell phone immediately enters the on state S51, then determines if the SIM card has been replaced S52. If not, the cell phone enters a normal operation state S63. However, if the SIM card has been replaced, the phone then determines if the protective password inputted matches the preset protective password S53. If so, the cell phone enters the normal operation state S63. Else, the cell phone determines if the PIN password matches the preset PIN password S54. If so, then the cell phone enters the normal operation state S63. Else, the cell phone activates the intelligent backup sequence 42. The above description covers activation and functionality of the intelligent theft discrimination sequence 41.

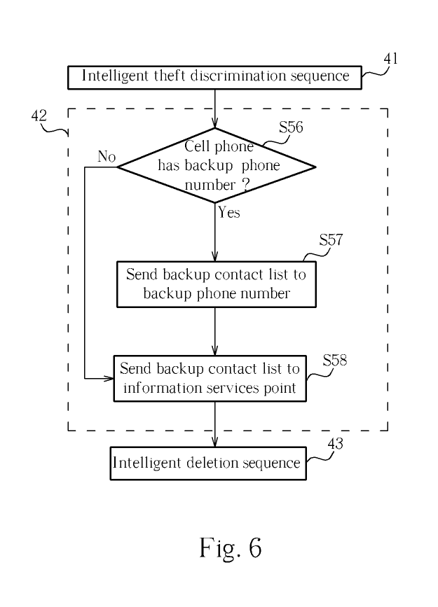

Please refer to FIG. 6, which is a flow chart describing activating the intelligent backup sequence 42 according to the present invention. If the intelligent theft discrimination sequence 41 has determined that the PIN password does not match the preset PIN password, the intelligent backup sequence 42 is activated to employ the backup mechanism and the SMS service. When the backup sequence 42 is activated S55, based on the electronic address preset by the user, the cell phone sends a backup contact list to a information services point S58. The cell phone also determines if a backup cell phone number has been set S56. If so, the cell phone sends the backup contact list to the backup cell phone number S57. Else, the cell phone activates the intelligent deleting sequence 43.

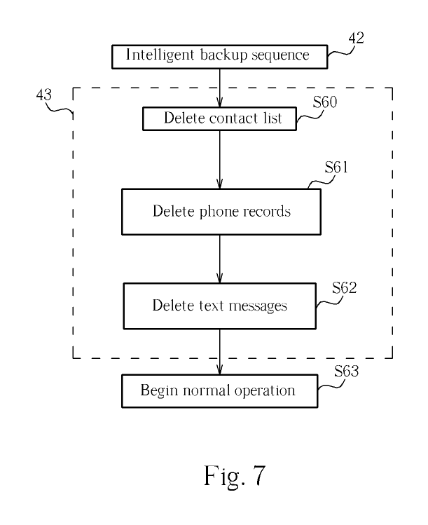

Please refer to FIG. 7, which is a flow chart of activating the intelligent deleting sequence 43 according to the present invention. After the cell phone completes the flow chart of FIG. 6 in the intelligent backup sequence 42, the cell phone activates the intelligent deletion sequence 43. The cell phone simultaneously deletes the contact list S60, deletes all phone call records S61, and deletes all text messages S62. Then, the cell phone enters normal operation S63.

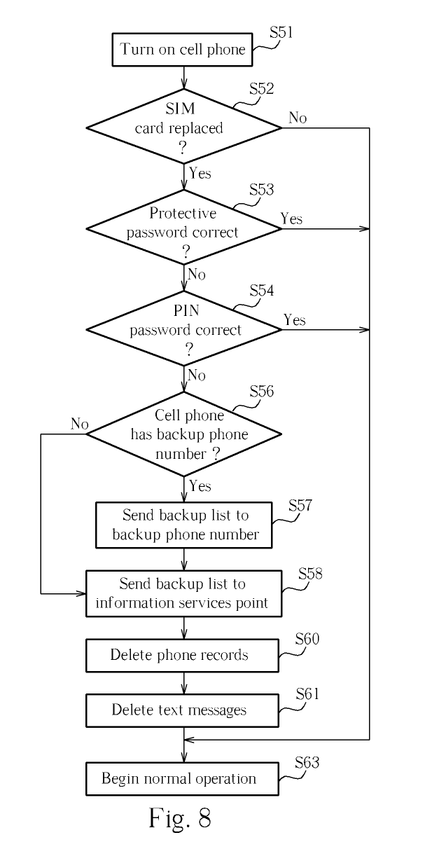

Please refer to FIG. 8, which is a complete flow chart for the present invention method of protecting the cell phone from information theft. As shown, the method comprises steps of:

Step S51: Turn on the cell phone;

Step S52: Has the SIM card been replaced? If yes, go to Step S53, else go to Step S63;

Step S53: Does the protective password match the preset protective password? If yes, go to Step S63, else go to Step S54;

Step S54: Does the PIN password match the preset PIN password? If yes, go to Step S63, else go to Step S56;

Step S56: Does the cell phone have the preset backup phone number? If yes, go to Step S57, else go to Step S58;

Step S57: Send the backup contact list to the preset backup phone number;

Step S58: Send the backup contact list to the information services point;

Step S60: Delete the contact list;

Step S61: Delete all phone call records;

Step S62: Delete all text messages; and

Step S63: Enter normal operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for backing up and protecting information in a mobile communication device comprising:
setting a protective password in the mobile communication device for providing a function of preventing the information from being stolen;
setting a PIN password in the mobile communication device for gaining access to a normal service;
setting an electronic address in the mobile communication device, the electronic address specifying a backup storage device; and
using a short message service in the mobile communication device to send information in the mobile communication device to the storage device when an inputted protective password does not match the protective password or an inputted PIN password does not match the PIN password.

2. The method of claim 1, wherein the mobile communication device is a cellular phone.

3. The method of claim 2 further comprising making a copy of the information in the mobile communication device.

4. The method of claim 3 further comprising deleting the information in the mobile communication device.

5. The method of claim 4, wherein making a copy of the information comprises making a copy of a communications record in the mobile communication device.

6. The method of claim 5, wherein deleting the information in the mobile communication device comprises deleting the communications record in the mobile communication device.

7. The method of claim 4, wherein making a copy of the information comprises making a copy of a contact list in the mobile communication device.

8. The method of claim 7, wherein deleting the information comprises deleting the contact list in the mobile communication device.

9. The method of claim 1, wherein the protective password comprises an alphanumeric sequence.

10. The method of claim 1, wherein the PIN password comprises an alphanumeric sequence.

11. The method of claim 1, wherein using a short message service in the mobile communication device to send information in the mobile communication device to the storage device comprises converting the information to packet signals.

12. The method of claim 1, wherein the electronic address in the mobile communication device comprises a mobile phone number.

13. The method of claim 1, wherein the electronic address in the mobile communication device comprises an email address.

14. The method of claim 1, wherein using a short message service of the mobile communication device to send information in the mobile communication device to the storage device comprises sending the information to a mobile phone which is the storage device.

15. The method of claim 1, wherein using a short message service of the mobile communication device to send information in the mobile communication device to the storage device comprises sending the information to a data services point which is the storage device.
